(19) United States
(12) Patent Application Publication
(10) Pub. No.: US 2019/0071022 A1
(43) Pub. Date: Mar. 7, 2019

(54) CONFIGURABLE STORAGE DEVICE FOR A MOTOR VEHICLE

(71) Applicant: FORD GLOBAL TECHNOLOGIES, LLC, Dearborn, MI (US)

(72) Inventors: Oscar Barradas Guarneros, Puebla (MX); Alma Elisa Lopez Rayon Morales, Puebla (MX); David Castro Duran, Nezahualcoyotl (MX); Luis Manuel Mendoza Vega, Santiago Tianguistenco (MX)

(21) Appl. No.: 15/694,529

(22) Filed: Sep. 1, 2017

(51) Int. Cl. B60R 7/02; B65D 25/28; B65D 71/52

(52) U.S. Cl. CPC B60R 7/02; B60R 2011/0059; B65D 71/0003; B65D 25/2808

(57) ABSTRACT

A configurable storage device includes a body having a base and multiple displaceable panels connected to the base by ratchet hinges. The body is displaceable between a home position and a deployed position. The deployed position includes various different configurations for holding different items or to meet the application needs of the user.

### TECHNICAL FIELD

This document relates generally to the motor vehicle equipment field and, more particularly, to a storage device incorporating a plurality of displaceable panels that may be configured in different ways to carry different articles and that may be stowed flat and integrated into the cargo compartment in an aesthetically pleasing manner and without occupying or interfering with full use of the storage space.

### BACKGROUND

Cargo compartments in motor vehicles are generally made as large as possible to store luggage and other items. As such, cargo compartments in most motor vehicles today include an expansive cargo floor. Smaller cargo items supported on this cargo floor are subjected to various acceleration, deceleration and cornering forces during operation of the motor vehicle. Often these forces cause one or more items of smaller cargo to move or shift around the trunk. At a minimum this produces a cluttered cargo area over time. Of greater concern, fragile cargo items, such as lightbulbs and eggs, might be damaged when displaced across the cargo floor or when engaged by other items being displaced across the cargo floor.

This document relates to a new and improved storage device adapted to be configured into a number of different, useful configurations suited for different applications and for the carrying of different cargo items. At the same time the storage device may be stowed in a manner that allows it to be fully integrated into the cargo compartment in a flat configuration so that when stowed the device does not consume any of the storage space of the cargo compartment. Advantageously, the configurable storage device is particularly easy to use and as such it represents a significant advance in the art

### SUMMARY

In accordance with the purposes and benefits described herein, a configurable storage device is provided. That configurable storage device comprises a body including a base and a first displaceable panel connected to the base by a first ratchet hinge. The body is displaceable between a home position and a deployed position.

The body may further include a second displaceable panel connected to the base by a second ratchet hinge. Further, the body may include a third displaceable panel connected to the base by a third ratchet hinge. Still further, the body may include a fourth displaceable panel connected to the base by a fourth ratchet hinge.

The configurable storage device may further include a cargo floor and a receiver in the cargo floor receiving and holding the body when the body is in the home position. That receiver may be recessed in the cargo floor. Thus, when the body is in the home position, an upper surface or face of the body may be flush with an upper face of the cargo floor.

The configurable storage device may further include a latching feature that releasably secures the body in the receiver. That latching feature may include an actuator, a locking pin and a linkage connecting the actuator to the locking pin. Further, the latching feature may include a locking pin receiver carried on the base. The locking pin receiver may be provided in a lug depending from the base.

The latching feature may be concealed under the body and, more particularly, the first displaceable panel in the receiver when the body is in the home position.

The configurable storage device may further include a handle carried on at least one panel of the first displaceable panel, the second displaceable panel, the third displaceable panel and the fourth displaceable panel. In addition, the configurable storage device may further include a first lifting tab connected to the first displaceable panel. A second lifting tab may be connected to the second displaceable panel. A third lifting tab may be connected to the third displaceable panel. A fourth lifting tab may be connected to the fourth displaceable panel. The first lifting tab, the second lifting tab, the third lifting tab and the fourth lifting tab may project from the receiver for easy access when the body is in the home position.

In the following description, there are shown and described several preferred embodiments of the configurable storage device. As it should be realized, the configurable storage device is capable of other, different embodiments and its several details are capable of modification in various, obvious aspects all without departing from the configurable storage device as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the configurable storage device and together with the description serve to explain certain principles thereof.

FIG. 1 is a detailed perspective view of the configurable storage device in the home position.

FIG. 2a is a detailed perspective view of the configurable storage device in a first deployed position wherein the four displaceable walls of the configurable storage device are oriented vertically in order to form a box.

FIG. 2b is a perspective view of the configurable storage device in a second deployed position wherein the displaceable panels thereof have been angled with respect to the base so as to be specifically adapted to hold a propane tank.

FIG. 2c illustrates the configurable storage device in a third deployed position with only one panel folded into a vertical orientation in order to aid in holding two pieces of the luggage between the vertically oriented panel and the rear surface of the rear seat of the motor vehicle.

FIGS. 3a-3c are a series of elevational views illustrating operation of the latching feature that secures the base of the configurable storage device in the receiver of the cargo floor.

FIG. 3a illustrates the latching feature in the locked position securing the base in the receiver.

FIG. 3b illustrates the latching feature in the partially unlocked position.

FIG. 3c illustrates the latching feature in the fully unlocked position wherein the locking pin of the latching feature is completely removed from the locking pin receiver provided in a lug depending from the base of the configurable storage device.

FIG. 4a is a perspective view of a motor vehicle illustrating the configurable storage device deployed for holding various items within the cargo compartment of the motor vehicle.

FIG. 4b illustrates the configurable storage device 10 removed from the motor vehicle for transporting items to a remote location.

Reference will now be made in detail to the present preferred embodiments of the configurable storage device, examples of which are illustrated in the accompanying drawing figures.

### DETAILED DESCRIPTION

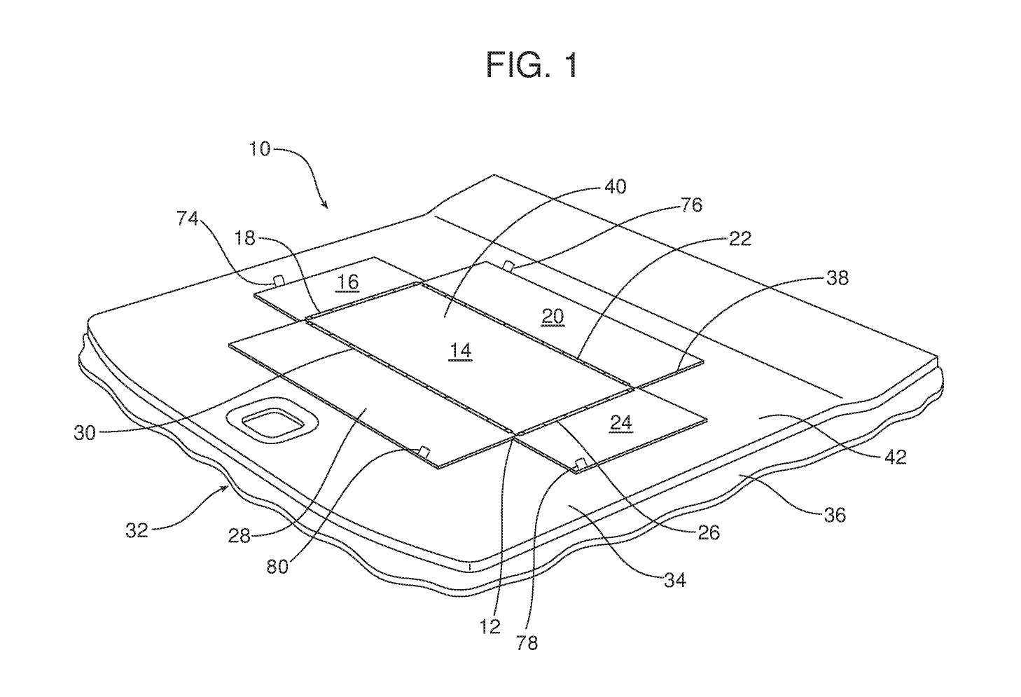

Reference is now made to FIGS. 1, 2a-2c, 3a-3c and 4a-4b which fully illustrate the new and improved configurable storage device 10. The configurable storage device 10 includes a body 12. The body 12 includes a base 14 having a four-sided perimeter. A first displaceable panel 16 is connected to a first side of the base 14 by a first ratchet hinge 18. A second displaceable panel 20 is connected to a second side of the base 14 by a second ratchet hinge 22. A third displaceable panel 24 is connected to a third side of the base 14 by a third ratchet hinge 26. A fourth displaceable panel 28 is connected to a fourth side of the base 14 by a fourth ratchet hinge 30.

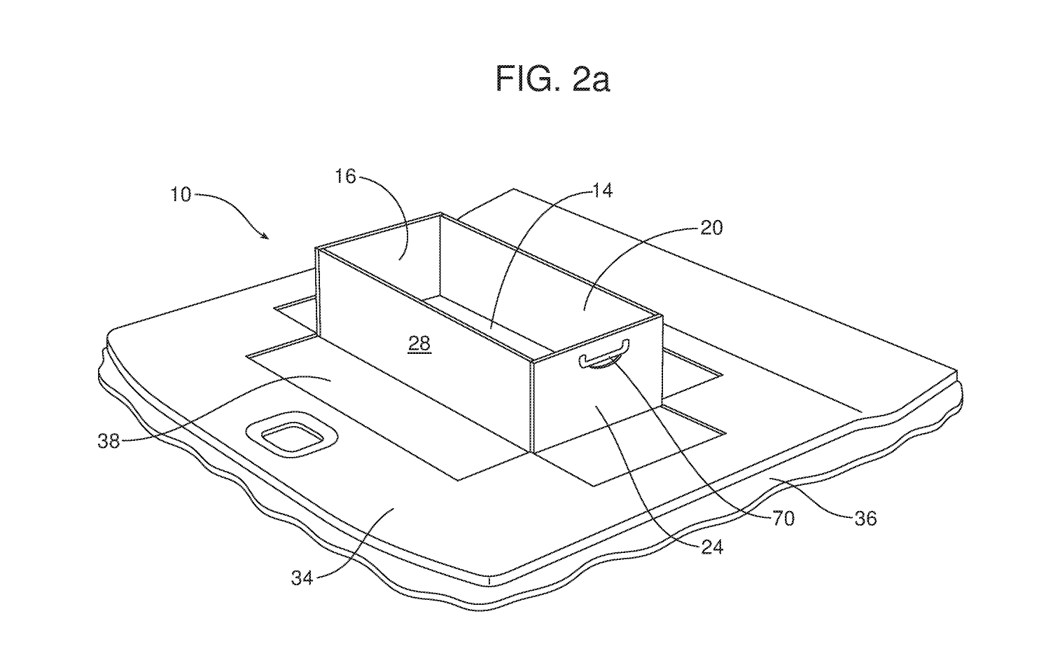

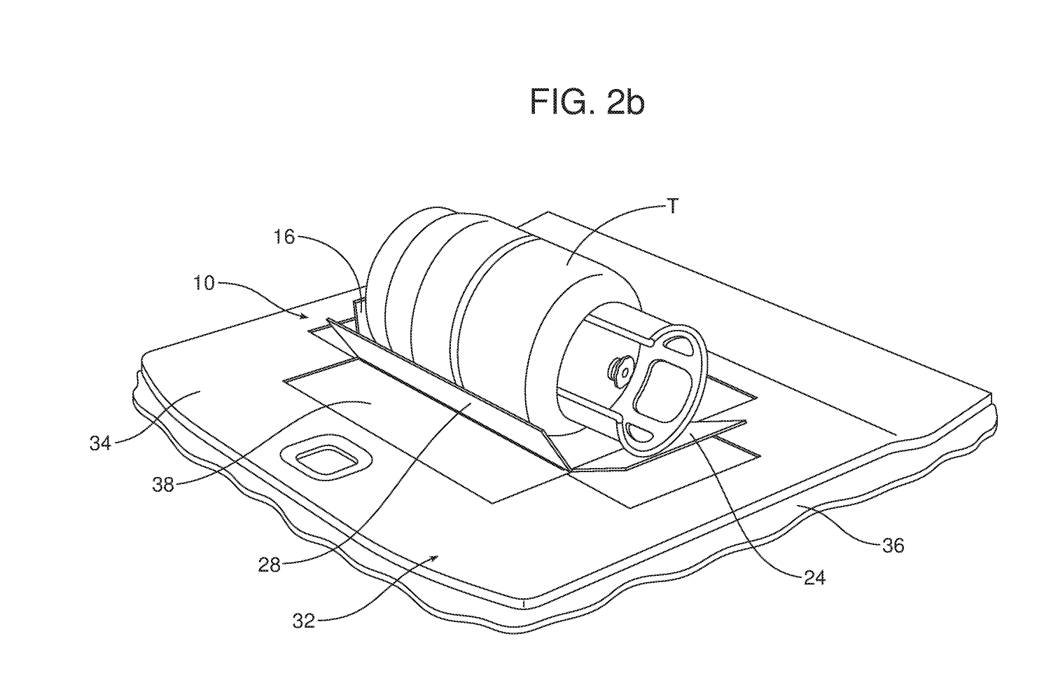

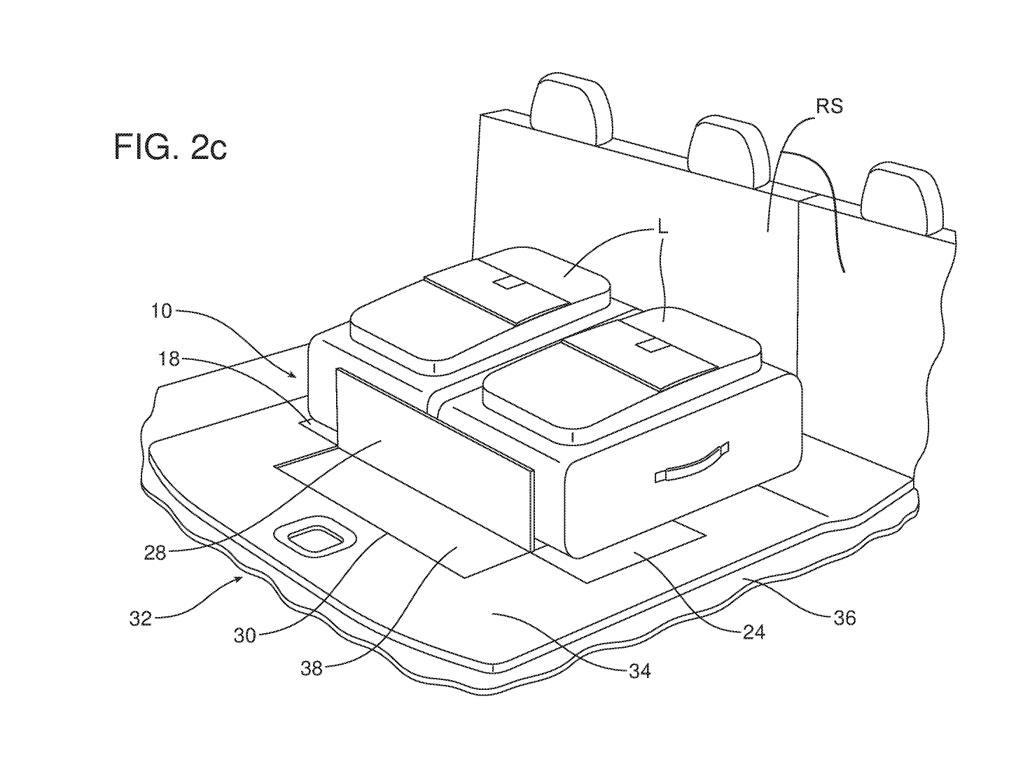

As will be apparent from reviewing FIGS. 2a-2c, the body is displaceable between a home position (as illustrated in FIG. 1) and a deployed position of any one of an infinite number of configurations, three of which are illustrated in FIGS. 2a-2c. More specifically, the ratchet hinges 18, 22, 26, 30 allow one to displace the respective displaceable panels 16, 20, 24, 28 at different, desired angles thereby allowing the body 12 of the storage device to be configured in a manner best suited or customized to carry a particular article or items of interest. Such ratchet hinges 18, 22, 26, 30 are commercially available from various manufacturers including Faurecia S.A. (automotive plastics manufacturer).

The configurable storage device 10 further includes a cargo floor 32 consisting of a floor cover 34 and a supporting super structure 36. A receiver 38 is provided in the cargo floor 32. The receiver 38 is adapted to receive and hold the body 12 when the body is in the home position (see FIG. 1). More specifically, the receiver 38 is recessed in the cargo floor 32 whereby when the body 12 is in the home position, an upper face 40 of the body 12 is flush with an upper surface or face 42 of the cargo floor 32. Thus, when stowed in the home position, the body 12 is fully integrated into the cargo floor 32 in an aesthetically pleasing manner. Further, when stowed, the body 12 does not encroach into the cargo area above the cargo floor 32.

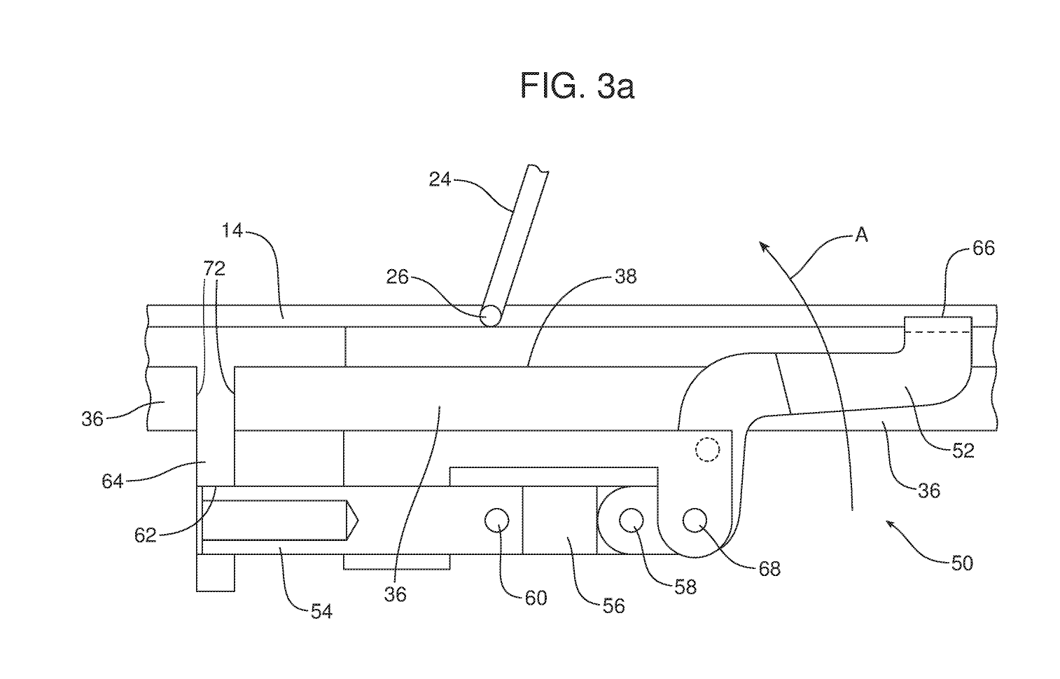

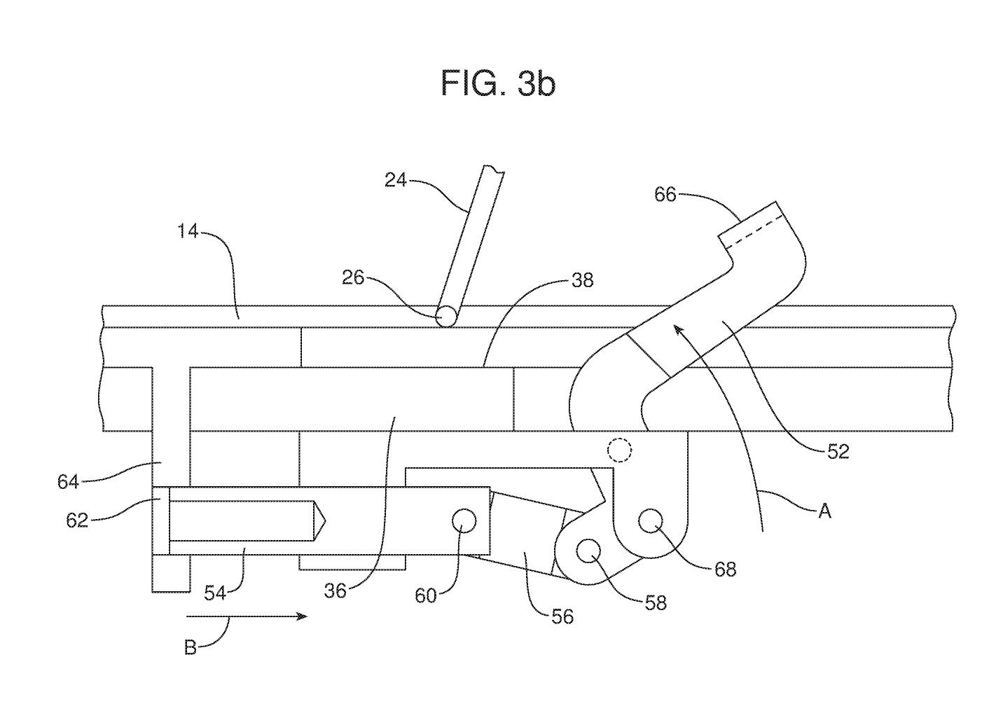

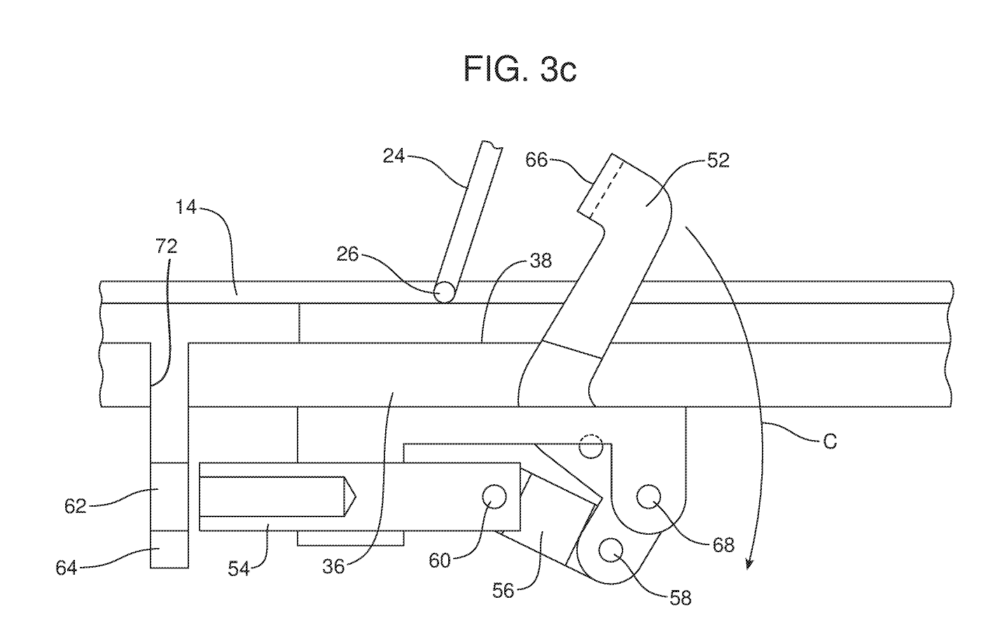

The configurable storage device 10 also includes a latching feature, generally designated by reference numeral 50, that is illustrated in FIGS. 3a-3c. The latching feature 50 functions to releasably secure the body 12 in the receiver 38 of the cargo floor 32. As illustrated, the latching feature includes an actuator 52, a locking pin 54 and a linkage 56 connecting the actuator to the locking pin. In the illustrated embodiment, the linkage 56 comprises a linking rod that is connected by a first pivot pin 58 to an end of the actuator 52 and a second pivot pin 60 to an end of the locking pin 54.

As further illustrated in FIGS. 3a-3c, the latching feature 50 also includes a locking pin receiver 62 carried on the base 14. In the illustrated embodiment, the locking pin receiver 62 comprises an aperture provided in a lug 64 depending from the base 14. The latching feature 50 is concealed under the body 12 in the receiver 38 when the body is in the home position. In the illustrated embodiment, the actuator 52 is revealed and made accessible when the third displaceable panel 24 is pivoted about the third ratchet hinge 26 in an upward direction out of the receiver 38.

FIG. 3a illustrates the position of the latching feature 50 when the latching feature 50 is locked to secure the body 12 in the receiver 38 of the cargo floor 32. As illustrated, the locking pin 54 is fully engaged in the locking pin receiver 62 of the lug 64 connected to the base 14. Further, the handle portion 66 of the actuator 52 is in a substantially horizontal configuration.

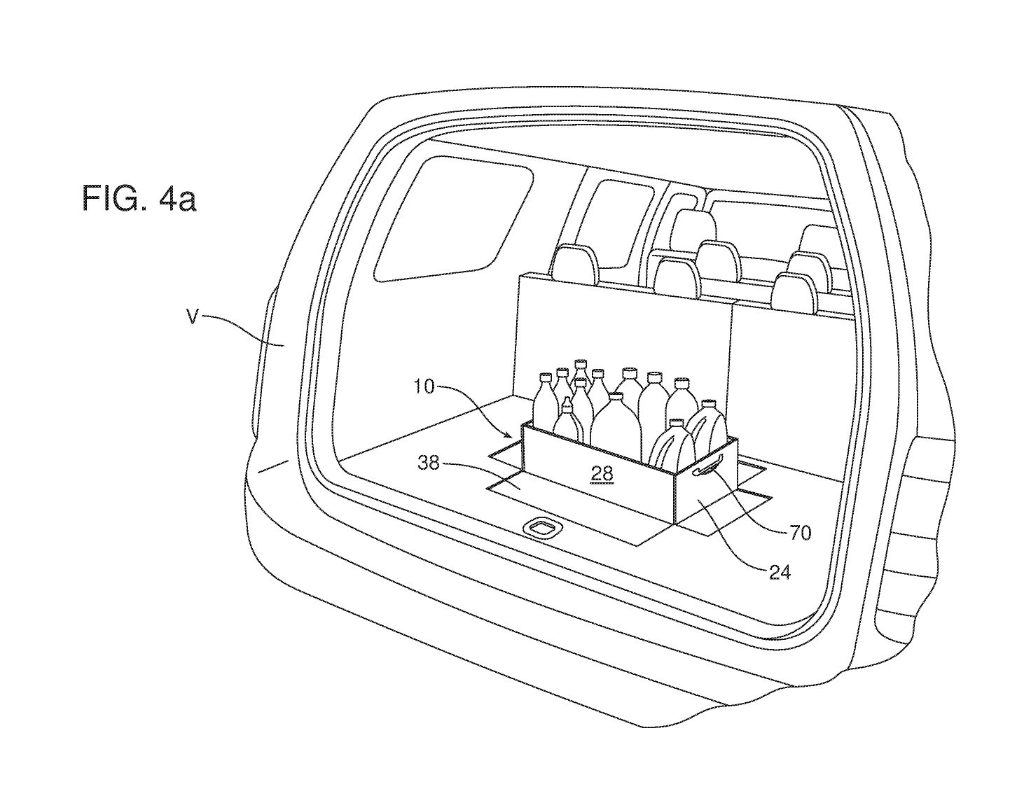

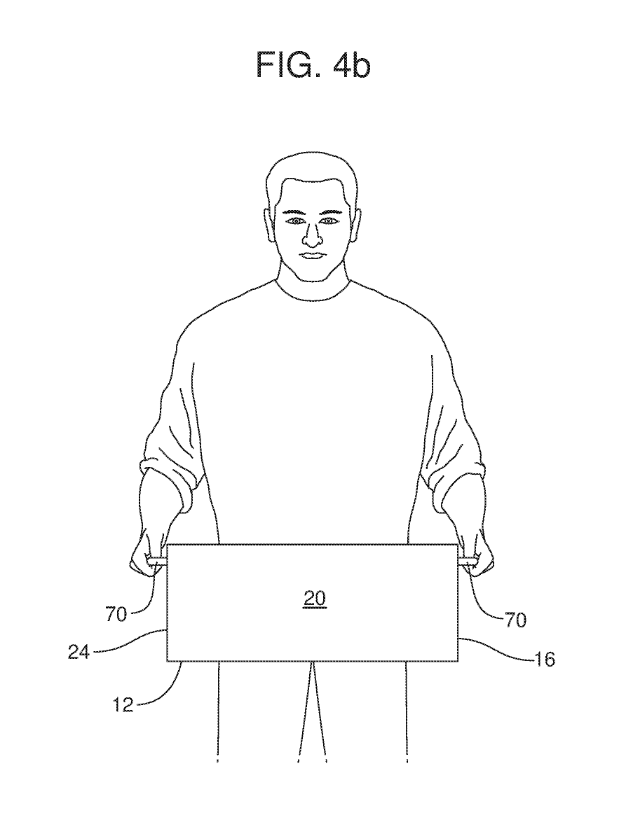

One releases the latching feature 50 by pivoting the actuator 52 about the pivot pin 68 which connects the actuator to the floor super structure 36. Note action arrow A. As this movement is made, the locking pin 54 is pulled in the direction of action arrow B out of the locking pin receiver 62 through the connection of the end of the actuator 52 with the locking pin 54 by means of the linkage 56. When the handle portion 66 of the actuator 52 is fully raised as illustrated in FIG. 3c, the locking pin 54 is free of the locking pin receiver 62 in the lug 64 of the base 14. Thus, the latching feature is unlocked and the body 12 of the configurable storage device 10 may be removed from the receiver 38 and used to carry or transport any items held therein to any location remote from the motor vehicle. Toward this end, at least one handle 70 is carried on at least one of the first displaceable panel 16, second displaceable panel 20, third displaceable panel 24 and fourth displaceable panel 28. See FIG. 4b. Preferably, at least two handles are provided, one on each of two opposed displaceable panels 16, 20, 24, 28. Of course, if desired a handle 70 could be provided on each of the displaceable panels 16, 20, 24, 28. The handles 70 may pivot and fit flush in the sidewalls 16, 24 when not in use.

The body 12 may be locked back in place within the receiver 38 in a quick and efficient manner. More specifically, the body 12 is positioned in the receiver 38 in a fully seated position with the lug 64 projecting through the aperture 72 in the floor super structure 36. The handle portion 66 of the actuator 52 is then pivoted in the direction of action arrow C (see FIG. 3c) about the pivot pin 68 until the handle portion is returned to the substantially horizontal position illustrated in FIG. 3a and the locking pin 54 is fully engaged in the locking pin receiver 62 in the lug 64. While only one latching feature 50 is illustrated in the drawing Figures, it should be appreciated that a second latching feature 50 may be provided at the opposite side or end of the base 14 and operated in the same manner if so desired. The structure of that second latching feature would be a mirror image of that illustrated in FIGS. 3a-3c.

Reference is now made to FIGS. 2a-2c which illustrate only three of the infinite number of possible configurations that may be assumed by the body 12 of the configurable storage device 10. As illustrated in FIG. 2a, the first displaceable panel 16, the second displaceable panel 20, the third displaceable panel 24 and the fourth displaceable panel 28 have all been pivoted upward about their respective ratchet hinges 18, 22, 26, 30 so as to form a box with an open top for receiving items to be held in the configurable storage device 10.

As illustrated in FIG. 2b, the first displaceable panel 16, the second displaceable panel 20, the third displaceable panel 24, and the fourth displaceable panel 28 have all been pivoted upwardly at appropriate angles about the respective ratchet hinges 18, 22, 26, 30 to correspond to, receive and hold the propane tank T so that the propane tank is held in place in the configurable storage device 10 and will not be displaced across the cargo floor 32 as might otherwise occur during operation of the motor vehicle if the configurable storage device 10 were not capable of providing this function.

As illustrated in FIG. 2c, the first displaceable panel 18, the second displaceable panel 20 and the third displaceable panel 24 are all maintained in their stowed position, horizontally oriented within the receiver 38. Only the fourth panel 28 has been pivoted upwardly into a horizontal position about the fourth ratchet hinge 30. Two pieces of luggage L are positioned between the upwardly projecting fourth panel 28 and the rear seat RS where they are held in position against displacement during acceleration and deceleration of the motor vehicle.

The configurable storage device 10 described herein provides a number of benefits and advantages. As illustrated by FIGS. 2a-2c, the configurable storage device 10 includes displaceable panels 16, 20, 24, 28 that may be pivoted about their respective ratchet hinges 18, 22, 26, 30 into any number of different configurations specially adapted for a particular user application and for holding up substantially any item of cargo and unusually shaped items such as, for example, the propane tank T as illustrated in FIG. 2b. When not in use, the body 12 may be stowed in a flat configuration within the receiver 38 of the cargo floor 32 where the body is flush with the cargo floor and does not encroach into the storage space of the cargo area. As illustrated in FIG. 4a, when deployed for use, the body 12 may hold any number of cargo items in an organized manner preventing them from being jostled about and displaced along the greater expanse of the cargo floor 32. Further, when desired, as illustrated in FIGS. 3a-3c, the latching feature 50 may be unlatched and as illustrated in FIG. 4b, the body 12 may be removed from the motor vehicle V to carry the items held therein to any remote location as desired by the user.

The foregoing has been presented for purposes of illustration and description. It is not intended to be exhaustive or to limit the embodiments to the precise form disclosed. Obvious modifications and variations are possible in light of the above teachings. For example, as illustrated in FIG. 1, a first lifting tab 74 may be connected to the first displaceable panel 16, a second lifting tab 76 may be connected to the second displaceable panel 20, a third lifting tab 78 may be connected to the third displaceable panel 24 and a fourth lifting tab 80 may be connected to the fourth displaceable panel 28. The lifting tabs 74, 76, 78, 80 may be placed on the upper face of the displaceable panels 16, 20, 24, 28 so as to be exposed for easy access when the displaceable panels are in the stowed position nesting in the receiver 38. Thus one may simply grasp one of the lifting tabs 74, 76, 78, 80 to lift/pivot any displaceable panel 16, 20, 24, 28 out of the receiver into a use position as desired. All such modifications and variations are within the scope of the appended claims when interpreted in accordance with the breadth to which they are fairly, legally and equitably entitled.

1. A configurable storage device, comprising:
a body including a base and a first displaceable panel connected to said base by a first ratchet hinge, said body being displaceable between a home position and a deployed position; and
a cargo floor and a receiver in said cargo floor receiving and holding said body when in said home position, said body being removable from said receiver in said cargo floor.

2. The configurable storage device of claim 1, wherein said body further includes a second displaceable panel connected to said base by a second ratchet hinge.

3. (canceled)

4. The configurable storage device of claim 2, wherein said receiver is recessed in said cargo floor whereby when said body is in said home position and upper face of said body is flush with an upper surface of said cargo floor.

5. The configurable storage device of claim 2, further including a latching feature releasably securing said body and said receiver.

6. The configurable storage device of claim 5, wherein said latching feature includes an actuator, a locking pin and a linkage connecting said actuator to said locking pin.

7. The configurable storage device of claim 6, wherein said latching feature includes a locking pin receiver carried on said base.

8. The configurable storage device of claim 7, wherein said locking pin receiver is provided in a lug depending from said base.

9. The configurable storage device of claim 8, wherein said body further includes a third displaceable panel connected to said base by a third ratchet hinge.

10. The configurable storage device of claim 9, wherein said body further includes a fourth displaceable panel connected to said base by a fourth ratchet hinge.

11. The configurable storage device of claim 10, wherein said latching feature is concealed under the body in said receiver when said body is in said home position.

12. The configurable storage device of claim 11, further including a handle carried on one panel of said first displaceable panel, said second displaceable panel, said third displaceable panel and said fourth displaceable panel.

13. The configurable storage device of claim 12, further including a first lifting tab connected to said first displaceable panel.

14. The configurable storage device of claim 13, further including a second lifting tab connected to said second displaceable panel.

15. The configurable storage device of claim 14, further including a third lifting tab connected to said third displaceable panel.

16. The configurable storage device of claim 15, further including a fourth lifting tab connected to said fourth displaceable panel.

17. The configurable storage device of claim 16, wherein said first lifting tab, said second lifting tab, said third lifting tab and said fourth lifting tab are exposed for access when said body is in said home position in the receiver.
